(19) United States
(12) Patent Application Publication
(10) Pub. No.: US 2008/0168033 A1
(43) Pub. Date: Jul. 10, 2008

(54) EMPLOYING MOBILE LOCATION TO REFINE SEARCHES

(75) Inventors: Edward Stanley Ott, Palo Alto, CA (US); Keith David Saft, San Francisco, CA (US); Marco Boerries, Los Altos, CA (US); Meher Tendjoukian, Burlingame, CA (US); Paul Yiu, San Francisco, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/620,619

(22) Filed: Jan. 5, 2007

(51) Int. Cl. G06F 17/30

(52) U.S. Cl. 707/3; 707/E17.014

(57) ABSTRACT

A system and method are directed towards refining mobile device search results using location modifiers. Information about a mobile device user may be collected, including a current location, a default location, information from address books, or other social networking information. The user may input a search query that is parsed into a primary search term and possibly a location modifier. The location modifier may modify the search for the primary search term by refining a physical location over which the search is performed. Location modifiers may include user-specific location modifiers that may employ social networking information to refine the search query, or a location sub-string modifier that refines the search query by employing a hierarchy of location data and/or social networking information. In one embodiment, where no location modifier is included within the search query, a current, or default, location of the mobile device may be employed.

### TECHNICAL FIELD

The present invention relates generally to search queries over a network and, more particularly, but not exclusively to refining a search using a mobile device by employing location information to modify a primary search query term.

### BACKGROUND

Tremendous changes have been occurring in the Internet that influence our everyday lives. For example, in today's society, mobile computing devices are becoming increasingly more common. Many mobile computing devices, such as personal digital assistants, cellular phones, and the like, may be employed to communicate voice messages, emails, text messages, and so forth, as well as to search for information over the Internet. It is not uncommon to see a person on a bus, train, or even a boat, to be using their mobile devices to search for merchants, restaurants, music, businesses, or the like.

However, performing a search query for user relevant information still remains cumbrous. Often, the user might have to perform several search queries to obtain relevant search results. Irrelevant search results mean that the user is less likely to find when they are looking for, which in turn may translate into lost opportunities for merchants, or other businesses, to prosper from the user. Therefore, many businesses are searching for new ways to make search results more relevant to the user. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 illustrates a logical flow diagram generally showing one embodiment of a process for refining a search query using location information; and

FIG. 5 illustrates a logical flow diagram generally showing one embodiment of a process for determining location information for use in refining the search, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “social network” refers to a concept that an individual's personal network of friends, family colleagues, coworkers, and the subsequent connections within those networks, can be utilized to find more relevant connections for a variety of activities, including, but not limited to dating, job networking, service referrals, content sharing, like-minded individuals, activity partners, or the like.

An online social network typically comprises a person's set of direct and/or indirect personal relationships, including real and virtual privileges and permissions that users may associate with these people. Direct personal relationships usually include relationships with people the user can communicated with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship.

Social networking information refers to various information about communications between the member and other members in the social network, including, but not limited to emails, Short Message Services (SMS) messages, Instant Messaging (IM) messages, Multimedia Message (MMS) messages, alerts, audio messages, phone calls, either received or sent by the member, or the like. Such social networking information may be obtained also from the member's address book, buddy list, or similar sources.

Briefly stated the present invention is directed towards refining mobile device search results using location modifiers. Information about a mobile device user may be collected, including a current physical location, a default physical location for the user, information from the user's address books, networking behavior, degrees of separation data, or other social networking information. The user of the mobile device may input a search query into a search application. The search query may be parsed into at least one primary search term and possibly a location modifier. If a location modifier is included, it may be used to modify the search for the primary search term by refining a physical location over which the search may be performed. Various types of location modifiers may be employed including user-specific modifiers, or user-specific modifiers that employ social networking information to refine the search query. A location sub-string modifier may also be employed to refine the search query by employing a hierarchy of location data and/or social networking information. In one embodiment, where no location modifier is included within the search query, a current, or default, location of the mobile device may be employed. Moreover, results of the search query may be organized into clusters (or grouped) by categories, and if the mobile device's current location is within a default location, the results may be displayed in an expanded version of the clusters (or groups); otherwise, the results may be displayed as collapsed clusters ( or groupings), showing merely categories.

### Illustrative Operating Environment

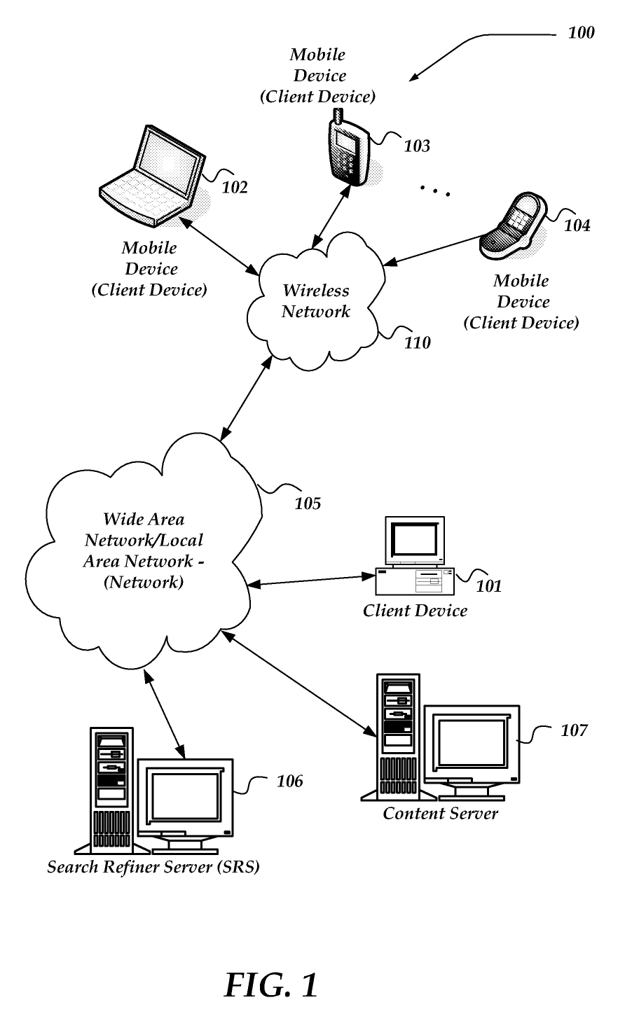

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, Search Refiner Server (SRS) 106, mobile devices (client devices) 102-104, client device 101, and content server 107.

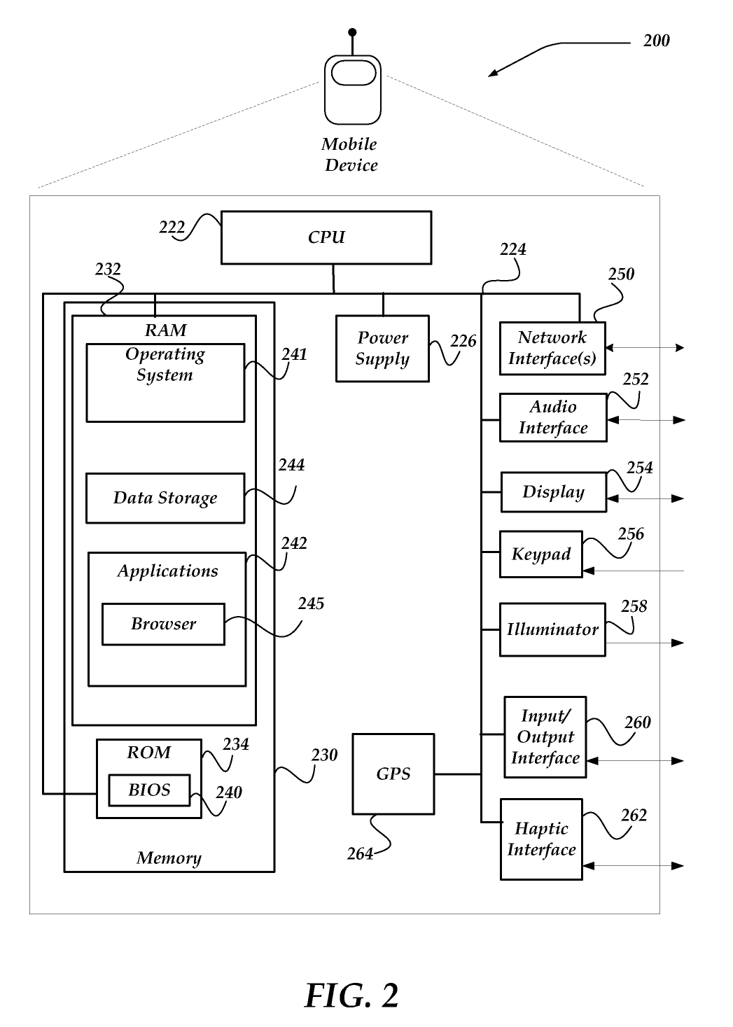

One embodiment of mobile devices 102-103 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the mobile device may employ the browser application to perform a search over a network. However, another application may also be used to perform a search over the network.

Mobile devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to SRS 106, client device 101, or other computing devices.

In one embodiment, mobile devices 102-104 may also provide a current physical location to another computing device. In one embodiment, mobile devices 102-104 may provide the current physical location information in terms of a latitude and longitude, or the like. However, mobile devices 102-104 may also provide other information that may be employed to determine a current physical location of the device, including for example, a MAC address, IP address, or the like. Such location information may be provided in a separate message, sent as part of another message, or even as a combination of the above. In one embodiment, physical location information may be provided on demand, or based on a time period, an event, or the like.

Mobile devices 102-104 may further be configured to include a client application that enables the end-user to log into an end-user account that may be managed by another computing device, such as SRS 106. Such end-user account, for example, may be configured to enable the end-user to receive emails, send/receive IM messages, SMS messages, access selected web pages, participate in a social networking activity, perform search queries, or the like. However, participation in various social networking activities, performing search queries, or the like, may also be performed without logging into the end-user account.

Client device 101 may include virtually any computing device capable of communicating over a network to send and receive information, including social networking information, performing search queries, or the like. Client device 101 may also include client applications such as those described above, as well as being configured to provide location information.

The set of such devices may include devices that typically connect using a wired or wireless communications medium such as personal computers, multiprocessor systems, microprocessor-based or programmable consumer electronics, network PCs, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102-104 and another computing device, network, and the like.

Network 105 is configured to couple SRS 106 and its components with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between SRS 106, client device 101, and other computing devices.

Additionally, communication media typically embodies computer-readable instructions, data structures, program modules, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

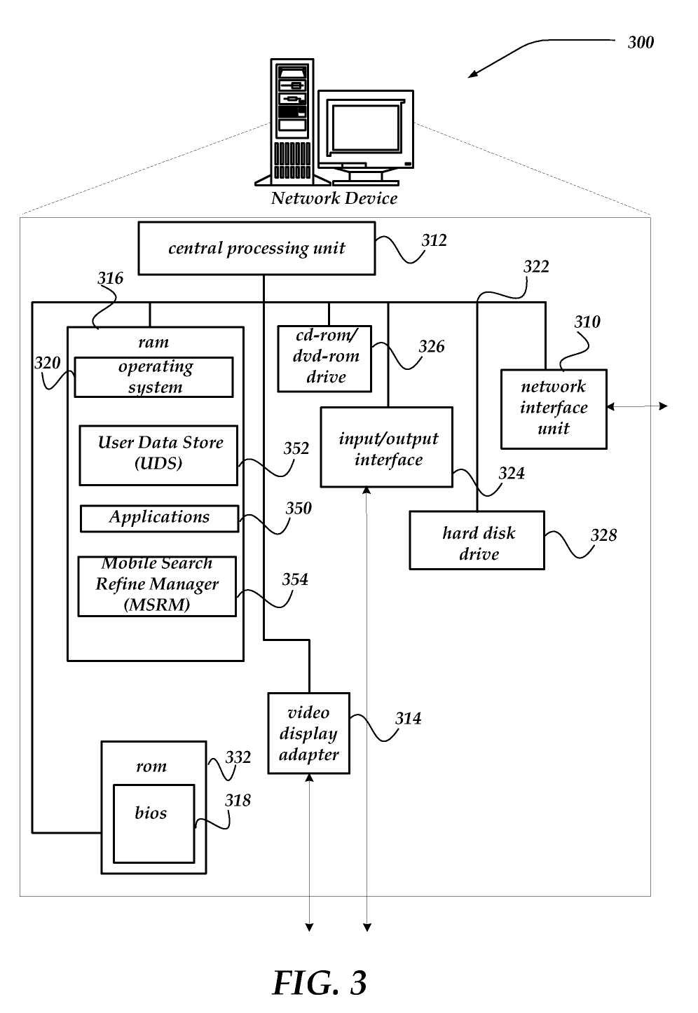

One embodiment of SRS 106 is described in more detail below in conjunction with FIG. 3. Briefly, however, SRS 106 may include any computing device capable of connecting to network 105 to enable aggregation and management of social networking information, and to receive and perform location refined search queries.

SRS 106 may receive from various participants in a social network, information including information associated with activities, events, messages, communications, address books, buddy lists, or the like. SRS 106 may also receive social networking information from a variety of other sources including, for example, content server 107. SRS 106 may store at least some of the received information for use in generating a location refined search query.

SRS 106 may be configured to receive a request for a search. SRS 106 may then parse the search query into at least one primary search term and zero or more location modifiers. SRS 106 may then employ the location modifiers, and/or social networking information, to refine the search query. SRS 106 may then provide the location refined search query results to the requesting client device.

Devices that may operate as SRS 106 include various network devices, including, but not limited to personal computers desktop computers, multiprocessor systems, microprocessor-based or programmable consumer electronics, network PCs, servers, network appliances, and the like.

Although FIG. 1 illustrates SRS 106 as a single computing device, the invention is not so limited. For example, one or more functions of SRS 106 may be distributed across one or more distinct computing devices. For example, managing various social networking activities and/or performing location refined search queries, may be performed by a plurality of computing devices, without departing from the scope or spirit of the present invention.

Content server 107 represents a variety of content and/or that may useable on mobile devices 102-104. Such services include, but are not limited to web services, third-party services, audio services, video services, email services, IM services, SMS services, VOIP services, calendaring services, photo services, or the like. Content may include web content, audio content, video content, FTP data, or the like. Moreover, information about the content and/or services provided by content server 107 may be employed to provide results to a search query.

Devices that may operate as content server 107 include personal computers desktop computers, multiprocessor systems, microprocessor-based or programmable consumer electronics, network PCs, servers, and the like.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, one embodiment of at least one of mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store social networking information including address books, buddy lists, aliases, or the like. At least a portion of the social networking information may also be stored on a disk drive or other storage medium (not shown) within mobile device 200.

Applications 242 may include computer executable instructions which, when executed by mobile device 200, transmit, receive, and/or otherwise process messages (e.g., SMS, NMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. One application shown in the figure is browser 245.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

In one embodiment, browser 245 may be configured to enable access to a search application, such as might be available through SRS 106 of FIG. 1. In one embodiment, a user of mobile device 200 may input to the search application a variety of search terms for use in obtaining a search results. Mobile device 245 may also provide location information, or information useable in determining its physical location. Such location information, may, in one embodiment, be useable to automatically (e.g., transparent to a user input) modify the search query.

### Illustrative Server Environment

FIG. 3 shows one embodiment of a network device, according to one embodiment of the invention. Network device 300 may include many more or less components than those shown. The components shown, however, are sufficient to disclose an illustrative embodiment for practicing the invention. Network device 300 may represent, for example, SRS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

As shown, User Data Store (IDS) 352 may include a database, text, spreadsheet, folder, file, or the like, that may be configured to maintain and store social networking information, including, but not limited to contact information including a contact name and at least one address or physical location associated with the contact name. The contact name may include an alias, a user name, or the like. The address may include an email address, an IM address, SMS address, a telephone number, IP address, or other information that may be useable to determine a physical location for the contact name.

In one embodiment, the contact information may be from or within a user's IM friends list, a buddy list, an address book, email history log, an IM conversation log, a VOIP store, or the like. However, the contact information may also be obtained indirectly through monitoring various interactions of a user. Thus, for example, the contact information may be extracted based on content within a message between the user and another member of a social network. For example, in one embodiment, the user and the other member may include information about a third person, or the like. Such third person information may also be obtained, in one embodiment, and stored within UDS 352. Similarly, various network behavior of a user, or other social networking member, may also be obtained, including, for example, websites visited, types of information searched for by the user, types of content downloaded, where the content is downloaded from, or the like. Information may also be obtained from another member's social networking contact information which may be useable for modifying a search by the user. Thus, second or higher degree of separation information may also be obtained from other members of the social network, and stored within UDS 352. In one embodiment, such information may be arranged and configured into a hierarchical relationship based, for example, on degrees of separation.

In one embodiment, location information based on a user's physical location, account registration information, or the like, may also be stored within UDS 352. Such information may indicate that the user resides in a particular town, neighborhood, city, or the like, within a particular county, state, country, or the like. Such location information may also be configured and arranged, in one embodiment, in a hierarchical relationship.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Mobile Search Refine Manager (MSRM) 354 may also be included as an application program within applications 350.

MSRM 354 is configured and arranged to receive a search query from a user, parse the search query into a primary search term(s), and if provided, location modifiers. Such location modifiers may be explicit location modifiers, user-specific location modifiers, and/or location sub-string modifiers, or the like. It is noted that in one embodiment, user-specific location modifiers, and/or location sub-string modifiers may be viewed as implicit location modifiers, in that they may include modifiers for which a location may be derived from a context.

Explicit location modifiers are those location terms that the user has explicitly entered that represent a physical location. Examples of such explicit location modifiers include a name of a city, state, country, county, or the like. For example, entering “San Francisco,” as part of the search query, would result in parsing an explicit location modifier of “San Francisco.” The term “location modifier” indicates that the location modifies or otherwise replaces a default or current physical location of the user's client device. Thus, if the user's client device, or registered user account indicates Seattle as the default or current physical location, but the explicit location modifier indicates San Francisco, then a search may be modified by the location “San Francisco.”

User-specific location modifiers may, in one embodiment, refer to those location terms that are related to a social networking aspect of the user, and/or a user-specified data term associated with a location. Thus, for example, if the user inputs the term “home,” the user-specific location modifier might be the physical location of the user's registered account address, or the like. Similarly, if the user inputs the term “joe,” or the like, then the user-specific location modifier might be a physical location based on a physical address associated with “joe,” where “joe” is a contact within the user's social network. Such contact may be determined based on a variety of criteria, including a degree of separation criteria, such as whether “joe” is located within the user's address book, buddy list, or other sources mentioned above. Thus, “joe” may be viewed as an implicit location modifier, in that the location is derived from the user's social networking context.

User-specific location modifiers may also be employed to modify other types of searches. For example, suppose the user inputs “Disneyworld paul.” MSRM 354 may parse this search query into a primary search term of “Disneyworld,” and a user-specific location modifier of “paul.” The search query may then be refined by MSRM 354 to perform a search for any information about Disneyworld associated with Paul, where Paul may be determined from the user's social network. For example, in one embodiment, Paul might be within the user's address book, or other contact source. Refining the search query, MSRM 354 might search for events, photographs, or other Disneyworld topics that are associated with Paul, Paul's advertised location, or the like. Thus, as illustrated, user-specific location modifiers may further include a variety of social networking information, beyond merely physical proximity refiners.

Location sub-string modifiers refer to those location terms that provide references to locations within a context such as the user's default or current location, or the like. Thus, for example, if the user's default location is San Francisco, then “mission” might be a location sub-string modifier that indicates the “Mission neighborhood.” If the user's default location is Seattle, then “mission” might be a location sub-string modifier that indicates a physical location associated with a building. Thus, location sub-string modifiers refine locations from a base location (e.g., a default or current location, or the like). Other examples of location sub-string modifiers include, but are not limited to addresses, landmarks, or the like.

In any event, as stated above, MSRM 354 may parse the received search query into a primary search term(s), and if provided, location modifiers. The primary search term(s) typically include information for which a user may perform a search over a network, and as such may include one or more search terms. Moreover, primary search term(s) may also include keywords that may be location modified by such as default location modifiers. Thus, for example, MSRM 354 may receive a keyword such as “today,” “NBA,” or similar type of keywords. The invention is not limited to such keywords, and any of a variety of other primary search terms may be designated as keywords that generate a specific category of results.

When a location modifier is not present within the received search query, then a default location or a current mobile device location may be used to modify the keyword. In one embodiment, the default location may also be a last used location, a last received location, a last user entered location, or the like. In one embodiment, the default location may be a location that the user entered during an account registration, client device registration, a billing location, mailing address location, or the like.

One example of using a default location is where the user enters a keyword such as “today,” and where the user's default location is Seattle. Then the primary search term “today” might be modified to generate a modified search query for a cluster of results based on events, or the like, in Seattle—today. However, the invention is not so limited and a current location of the user's client device may also be used.

In one embodiment, MSRM 354 may further be configured and arranged to enable clustering of the search results. Moreover, in one embodiment, MSRM 354 may expand or collapse the clustered results based on a current location of the user. Thus, for example, in one embodiment, when the user is determined to be in a location other than a default location, such as visitor to another city, or the like, the clustered results might be collapsed. If the user is determined to be currently within a default location for the user, the clustered results might be expanded. However, the invention is not so constrained. For example, in another embodiment, the expansion or collapsing of the clustered results might be reversed from described above or always expanded, or even always collapsed, without departing from the scope of the invention.

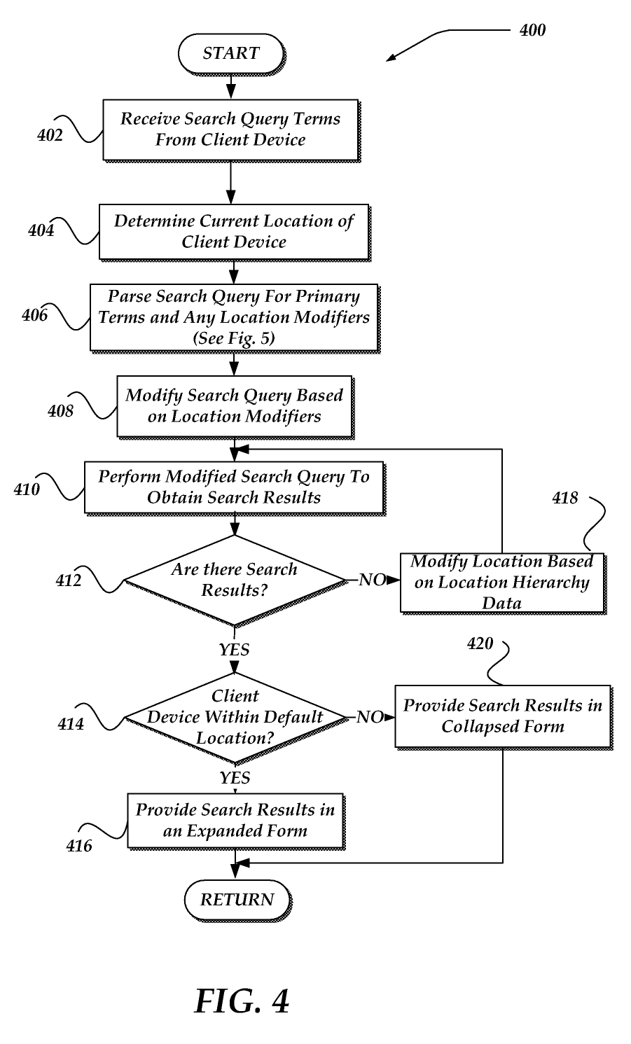

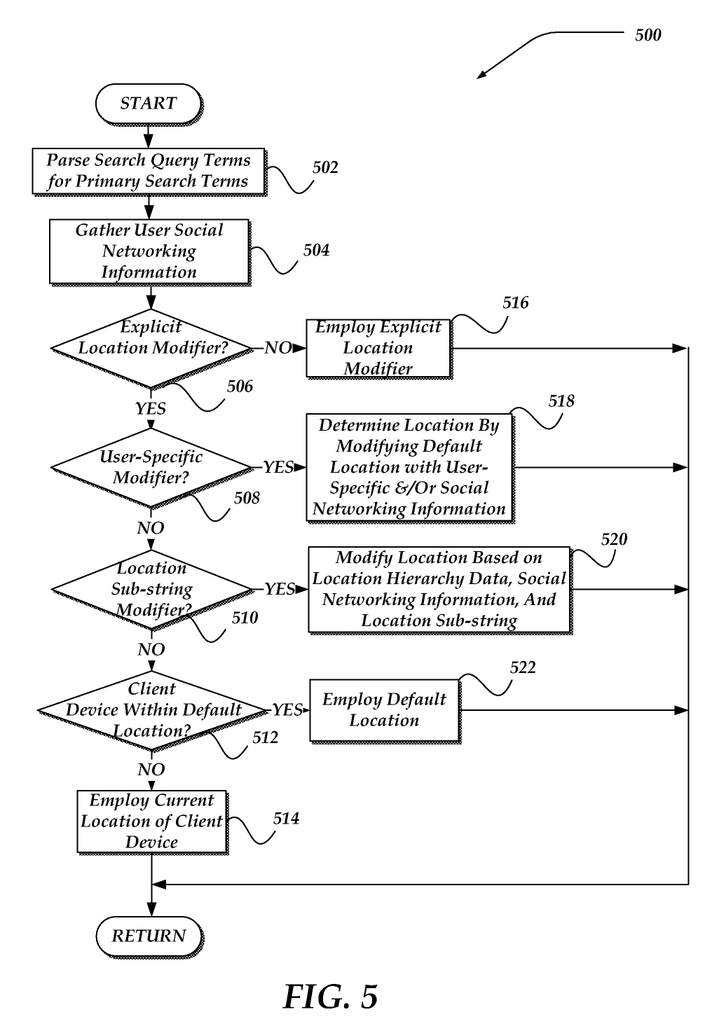

In another embodiment, MSRM 354 may determine whether the result of the search query is an empty set, or otherwise insufficient-based on various criteria, including a number of search results, or the like. In this embodiment, MSRM 354 may modify the location information to expand the search modifier location. In one embodiment, MSRM 354 may structure location information into a hierarchy, tree, or the like, that may then be used to modify the location modifier. Thus, for example, where the location modifier is presently a particular town, MSRM 354 may crawl the hierarchy of location information, for a neighboring town, a county, or other related locations that might provide more search results. MSRM 354 may, in one embodiment, employ processes substantially similar to those described below in conjunction with FIGS. 4-5 to perform at least some of its actions.

Moreover, although illustrated within network device 300, it should be understood, the MSRM 354, UDS 352, or the like, may reside also reside within different network devices, network appliances, or the like.

### Generalized Operation

The operation of certain aspects of the invention will now be described with respect to FIGS. 4-5. FIG. 4 illustrates a logical flow diagram generally showing one embodiment of a process for refining a mobile search query using location modifiers. In one embodiment, process 400 of FIG. 4 may be employed within MSRM 354 of FIG. 3.

Process 400 begins after a start block, at block 402, where a user's search query is received over a network. In one embodiment, the user's search query is received where the user is employing a mobile device. However, the invention is not so limited. For example, the invention may also be employed for search queries that are performed using a non-mobile client device, such as client device 101 of FIG. 1.

In any event, processing flows next to block 404, where a physical location of the user's client device is determined. In one embodiment, the physical location may be determined based on a message, or other communications received from the user's client device. In another embodiment, another device may provide the location of the user's client device.

Process 400 then flows to block 406, which is described in more detail below in conjunction with FIG. 5. Briefly, however, at block 406, the received search query is parsed into at least one primary term and if provided one or more location modifiers. In one embodiment, as illustrated in FIG. 5, if no location modifier is provided a default or a current location may be provided for use in refining the search query. Thus, in one embodiment, a location modifier might always be used to refine search queries, whether the location modifier is explicitly provided, implicitly provided, or is a default or a current location.

Processing continues next to block 408, where the location modifiers are employed to refine the search query. Processing flows to block 410, where the modified search query is used to perform a search. Any of a variety of search applications may be used to perform the search for results, thus, the invention is not constrained by the search application. Thus, in one embodiment, the search application may be configured and arranged to employ location information that is provided explicitly within a same string of search terms. In another embodiment, the location information may be provided to the search application within a “must have,” or “having at least one of,” or the like. In yet another embodiment, the search applications may be directed to a database, data store or the like, that may be configured and arranged based on location information.

In any event, processing continues to decision block 412, where a determination is made whether search results are received based on the location refined search query. Such a determination may be based on whether a minimum number of results are returned, in one embodiment, whether the search results reflect the location modifier refinement, or some other defined criteria. If the search results do not satisfy the defined criteria, processing branches to block 418; otherwise, processing flows to decision block 414.

At block 418, the location modifier may be automatically modified based on location hierarchy data. Thus, for example, if the refined search query was for news articles for the location Sunnyvale, but none or an insufficient number (per the defined criteria) were found, then the location hierarchy data may be crawled to expand the location modifier. For example, the region may be expanded based on crawling the location hierarchy data to include a neighboring town (such as Palo Alto), a county (such as Santa Clara), or the like. Thus, the location data may include location information structured and arranged in a location hierarchy for various locations. Once the location modifier is modified based on crawling the location hierarchy data, the processing returns to block 410 to perform the search until the search results satisfy the criteria. In one embodiment, however, the number of searches may be limited to constrain a number of search attempts.

In any event, if the search results satisfy the criteria, in one embodiment, they may be clustered or grouped into categories. Such categories may be determined based on any of a variety of criteria, including pre-defined categories, common results, or the like.

At decision block 414, a determination is made whether a current location of the user's client device (from block 404) is within a default location identified with the user. Such comparison may indicate whether the user is currently visiting another location. If it is determined that the current location is outside of a default location processing flows to block 420; otherwise, processing flows to block 416.

At block 420, when the user is determined to be in a location other than a default location, the clustered (or grouped) results might be sent to the user's client device in a collapsed category format. That is, in one embodiment, a category title might be displayed to the user, rather than each of the results within the category grouping. The user may then, in one embodiment, select a category title to expand that category, select an “expand all” option, or the like. Processing then returns to a calling process to perform other actions.

At block 416, if the user is determined to be currently within a default location for the user, the clustered or grouping results might be sent to the user's client device in an expanded category format. That is, each of the search results within a category grouping may also be displayed, a subset of information about each result may be displayed, or the like. In one embodiment, the user may select a category title to collapse the category.

However, in another embodiment, at block 416, no category titles might be provided to the user. Moreover, the invention is not so constrained to employing categories as described above. For example, in another embodiment, the expansion or collapsing of the clustered results might be reversed from described above, or always expanded, or even always collapsed, or the like, without departing from the scope of the invention. In any event, upon completion of block 416, processing returns to the calling processing to perform other actions.

FIG. 5 illustrates a logical flow diagram generally showing one embodiment of a process for determining mobile location information for use in refining the mobile search. Process 500 of FIG. 5 may represent, one embodiment, of block 406 of process 400 of FIG. 4. However, the invention is not so constrained, and other embodiments of block 406 may also be employed, without departing from the scope of the invention.

In any event, process 500, begins, after a start block, at block 502, where the received search query is parsed into at least one primary search term and zero or more location modifiers.

Processing continues to block 504, where social network information may be obtained for the user. Determination of the user may be based on a variety of criteria, including, but not limited to information obtained directly from the user, information obtained about the user's client device, log-in information from the user, or the like.

In one embodiment, gathering of social networking information may include obtaining contents of an address book, buddy list, email addresses, network purchases, prior searches, prior locations associated with the user's client device, or the like. In one embodiment, such information may be gathered by another process that may be configured and arranged to monitor the user's online activities and to collect information based on the user's actions online. In another embodiment, at least some of the information, such as address books, buddy lists, or the like, may be obtained from the user providing them for storage by a server data store, or the like. In any event, a variety of user related social networking information may be collected for use within process 500. It should be noted, however, the block 504 may also be performed separately from process 500, for example, as part of process 400, or another process. Moreover, block 504 may also be performed in conjunction, or even before block 502.

In any event, processing then continues to decision block 506, where a determination is made whether the parsed search query includes an explicit location modifier, such as described above. If so, processing branches to block 516; otherwise, processing flows to decision block 508.

At block 516, the explicitly provided location modifier may be employed to refine the primary search term(s) within the search query. Processing then returns to a calling processing to perform other actions.

At decision block 508, a determination is made whether a user-specific location modifier is included for the parsed search query. If not, processing continues to decision block 510; otherwise processing continues to block 518.

At block 518, the user-specific location modifier may be used to refine the search query. In one embodiment, the user-specific location modifier may include user-specific data, such as “home,” or the like. If so, then refining the search query may include determining a physical location associated with the user-specific location data (e.g., “home”), and modifying the primary search term with the resultant physical location. In another embodiment, the user-specific location modifier may include an implicit reference to social networking information, such as a person's name, an event, a party, or the like. In this instance, the social networking information collected for the user may be employed, at least in part, to locate a physical location associated with the user-specific data. The process may then return to the calling process to perform other actions.

At decision block 510, a determination is made whether a location sub-string modifier, as described above is included within the parsed search query. If a location sub-string modifier is provided, processing flows to block 520; otherwise processing continues to decision block 512.

At block 520, in one embodiment, a physical location associated with the location sub-string modifier may be obtained using a location hierarchy data, social networking information, or the like. In one embodiment, the location sub-string modifier may modify a location associated with a default location of the user, a current location of the user, or the like. Thus, if it is determined, for example, that the location sub-string modifier is an address, such as “707 Guerroro,” or the like, this datum may be combined with information about a current location, or a default location. The resulting combination may indicate, for example, that the user is performing a search for a primary search term associated with the mentioned address, within a current regional location (e.g., San Francisco).

The primary search term may then be refined based on the address within the current regional location. However, the invention is not constrained to this example, and clearly, other location sub-string modifiers may also be received, including for example, a neighborhood identifier, a landmark, or the like. Such information may then be employed to modify a current location, or the like, to refine the search query. In any event, processing then returns to the calling process to perform other actions.

At decision block 512, a determination is made whether the client device is within a default location as described above. If it the client device is within the default location, then processing flows to block 522, where the search query's primary search term may be modified with the default physical location of the client device. Processing then returns to the calling process to perform other actions.

However, if it the client device is outside of the default location, then processing flows to block 514, where the search query's primary search term may be modified with a current physical location of the client device. Processing then returns to the calling process to perform other actions. Thus, as described above, in one embodiment, each search query may be modified with location information, whether it is explicitly provided by the user, implicitly provided, or is a default or current location.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device to manage a search query from a mobile device over a network, comprising:
a transceiver to send and receive data over the network; and
a processor that is operative to perform actions, including:
receiving a search query from the mobile device;
parsing the search query into at least one primary search term, and zero or more location modifiers;
if a location modifier is parsed from the search query, using the location modifier to determine a physical location;
refining the search query based on the at least one primary search term and the determined physical location; and
performing a search using the refined search query.

2. The network device of claim 1, wherein the actions further comprising:
if a location modifier is unparsed from the search query then determining a physical location based on one of a current location or a default location associated with the mobile device.

3. The network device of claim 1, wherein the actions further comprising:
if the result of the refined search query fails to satisfy a search criteria, then modifying the physical location and performing another refined search query based, in part, on the modified physical location.

4. The network device of claim 1, wherein the location modifier is one of a user-specific location modifier, or a location sub-string modifier.

5. The network device of claim 1, wherein the location modifier further comprises a user-specific location modifier, wherein the physical location is determined based on social networking information associated with a user of the mobile device.

6. The network device of claim 1, wherein the location modifier further comprises a location sub-string modifier that modifies a default or current location of the mobile device to determine the physical location for refining the search query.

7. A system that is operative to manage a search query over a network, comprising:
a client device that is configured and arranged to enable actions, including:
sending a search query over the network; and
receiving a search result based on the refined search query; and
a network device that is configured and arranged to perform actions, including:
receiving the search query from the client device;
parsing the search query into at least one primary search term, and zero or more location modifiers;
if a location modifier is parsed from the search query:
determining a physical location based, in part, on the location modifier,
refining the search query based on the at least one primary search term and the determined physical location; and
performing a search using the refined search query.

8. The system of claim 7, wherein the client device is enabled to perform actions further comprising:
providing social networking information useable by the network device, in part, to determine the physical location.

9. The system of claim 7, wherein the location modifier further comprises implicit location information, and wherein the physical location is determined based on modifying at least one of a current or a default location of the client device based on the implicit location information.

10. The system of claim 9, wherein the implicit location information further comprises a user-specific modifier that is determinable based on social networking information.

11. The system of claim 7, wherein if a location modifier is absent from the parsed search query, then the network device is configured and arranged to employ at least one of a default location or a current location of the client device to refine the search query.

12. A computer-readable storage medium having computer-executable instructions for managing a search query over a network, the computer-executable instructions when installed onto a computing device enable the computing device to perform actions, comprising:
receiving a search query from a client device;
parsing the search query into at least one primary search term, and zero or more location modifiers;
determining a physical location based, in part, on the zero or more location modifiers;
refining the search query based on the at least one primary search term and the determined physical location; and
performing a search using the refined search query.

13. The computer-readable storage medium of claim 12, wherein determining the physical location further comprises:
if a location modifier is parsed from the search query, using the location modifier to determine a physical location; and
if a location modifier is unparsed from the search query, using at least one of a default location or a current location for the client device to determine the physical location.

14. The computer-readable storage medium of claim 12, wherein the actions further comprising:
receiving social networking information associated with a user of the client device, and employing the social networking information with the location modifier to determine the physical location.

15. The computer-readable storage medium of claim 12, wherein performing the search further comprises:
if a number of search results is below a defined number of search results, employing hierarchical location information to modify the physical location;
modified the refined search query using the at least one primary search term and the modified physical location; and
performing another search using the modified search query.

16. The computer-readable storage medium of claim 12, wherein at least one location modifier comprises a user-specific location modifier that is refers to a physical location associated with a user of the client device.

17. A method of performing a search query over a network, comprising:
sending, from a mobile device, a search query having a primary search term;
determining, by the server device, a physical location based, in part, on zero or more implicit location modifiers within the search query;
refining, by the server device, the search query based on the primary search term and the determined physical location;
performing at least one search using the refined search query; and
providing at least one search results to the mobile device over the network.

18. The method of claim 17, wherein determining a physical location further comprises determining a default or a current location of the mobile device, and employing the implicit location to modifier the default or current location.

19. The method of claim 17, wherein the primary search term is a keyword, and wherein the physical location refines the search query to search for information associated with the keyword for the physical location.

20. The method of claim 19, wherein the keyword further comprises the term “today,” and the physical location refines the search query to search for information associated with the physical location for today.

21. The method of claim 17, wherein providing the search results further comprises:
providing the search results in a collapsed or an expanded category format based on whether the mobile device is within a default location.

22. A modulated data signal configured to include program instructions for performing the method of claim 17.
